(19) United States
(12) Patent Application Publication
(10) Pub. No.: US 2012/0135386 A1
(43) Pub. Date: May 31, 2012

(54) Relating psychological characteristics to on-screen drawings

(76) Inventor: Ben Zaneti, Rosh Ha'ayin (IL)

(21) Appl. No.: 13/305,307

(22) Filed: Nov. 28, 2011

Related U.S. Application Data
(60) Provisional application No. 61/417,446, filed on Nov. 28, 2010.

(51) Int. Cl. G09B 19/00

(52) U.S. Cl. 434/236

(57) ABSTRACT

A method and system for digitally relating psychological characteristics of a subject to on-screen drawings, comprising—
providing a display screen and graphic input means that enable the subject to graphically interact with the screen, the interaction including drawing a sequence of strokes, the strokes being associated with a plurality of parameters, at least one parameter being temporal and at least one parameter being geometric;
providing a data base that contains relations between stroke parameters and psychological characteristics;
letting the subject to graphically interact with the screen and capturing and storing values of parameters corresponding to one or more strokes drawn by the subject in any of the sequences;
and relating the captured parameter values from one or more of the sequences to contents of the data base.

Optionally, one parameter is of force exerted during drawing.

The present application claims priority from provisional patent application No. 61/417,446, filed at the USPTO on 28 Nov. 2010 under the title “Apparatus and System for Monitoring and Diagnosing Stress in a Child through Drawings”.

### FIELD OF THE INVENTION

The field of the invention is the relation between freehand drawings of a subject and his psychological state. More particularly, the invention concerns apparatus and method for digitally relating on-screen drawings to psychological characteristics.

### BACKGROUND

Children are often subjected to stressful situations, especially when away from home—e.g. in care centers, kindergartens and schools—but also at home when in the care of insufficiently competent adult or older child. Sometimes such situations may be traumatic, possibly involving aggressive acts toward the child, including beating, molestation, sexual harassment, etc. A child generally does not report his stressful experience—either because he cannot verbalize it or is afraid or feels guilty. Instead, the experience is internalized and results in psychological stress, which is often, but not always, manifest in detectable abnormal behavior patterns. It is, however, known that such experiences, or the resulting stress, are expressed in various ways in the child's drawings. There exists a rich literature on the subject of the meaning of various features and parameters in the drawings as they relate to stressful and traumatic experiences, and psychological testing often includes analyzing a subject's drawings in order to detect stresses and to diagnose their roots, possibly pointing to particular types of experiences or even to the identity or character of particular persons that may be responsible for them.

Unfortunately, such psychological testing is usually undertaken only after abnormal behavior of the child has been observed for a while by his parents or teachers. By that time much stressful experience may have accumulated in the child, especially in cases of continuing aggressive acts toward him, so that preventive and remedial action becomes more difficult. A regime of periodic psychological testing may alleviate this difficulty, detecting stressful situations early. However, such regime is naturally expensive and may not be suitable for covering entire populations.

Another disadvantage of conventional application of drawings analysis in psychological testing is that drawings to be analyzed are either made by the subject in situ or are randomly collected from a child's past drawings. In the former case, the testing environment may adversely affect the nature of the drawings as reflecting the subject's psychological state, but, on the other hand, the tester may observe the dynamics of the drawing process, which can add useful information. In the latter case (of randomly collected past drawings), the selected drawings may not necessarily be the ones that would be most meaningful for the tester, or not enough drawings may have been kept or even produced at all; also in this case, at least some of the dynamics of the drawing process have been lost.

Some effort is spent on training teachers to routinely analyze drawings for signs of stress. However, such efforts are sporadic and not all teachers may become thus qualified; also, again, scarce time and money are required to make this widespread and effective.

There is thus a need for a method that enables easy acquisition of drawings from children and ready analysis of the drawings, to detect stresses, without directly involving trained personnel. The method should, moreover, consider dynamic, or real-time, aspects of the drawings and the drawing process, which may convey further information about the psychological state of the subject. There is also a need for inexpensive apparatus for enabling subjects, especially children, to draw at their leisure and for capturing the drawings at any time; clearly such apparatus should be based on digital technology.

There exist software programs, such as “ESPD2007 Psychological Analysis of Drawings”, available from AIS Hungary, that perform a psychological analysis on drawings (which have been scanned and digitized), using artificial intelligence techniques, and issue a psycho-diagnostic report. Such a program indeed enables detecting certain symptoms, using a home computer. However it still requires collecting drawings made on paper and scanning them; it also has the disadvantage of being blind to the real-time dynamics of the drawing (which would be observable during conventional psychological testing).

In patent publication WO2010050767 (by Kim Seong-In) there is disclosed a software program that lets a subject being tested compose a drawing on a computer screen out of various patterns displayed to him; the composition is then analyzed for psychological symptoms. Although some real-time dynamics may be captured by such a program, it is much more restrictive on the subject's expressiveness than a freehand drawing and thus may have rather limited effectiveness.

In addition to the problems discussed above, concerning children, there are situations in which also certain psychological characteristics of adults may have to be ascertained and this may possibly be achieved by examining drawings and, particularly, the drawing process. Such situations may include, for example, considering a candidate for employment or for particular tasks, checking veracity of a witness or a suspect in a criminal investigation or monitoring psychiatric patients. Many of these situations, as well, the desired examination may be carried out more effectively and economically with a digital system.

While there may exist a corpus of accumulated empirical information about the relationship between drawings and psychological characteristics, such information is associated primarily with drawings on paper and thus does not include dynamic characteristics of the drawing process, such as speed and timing of strokes or the pressure exerted by the drawing tool. It is reasonable to assume that inclusion of such characteristics in the empirical information will enhance its effectiveness, especially when applied to digital diagnosis methods, such as disclosed herein. There is therefore a need for a method to conveniently and systematically collect dynamic drawing data from a large number of subjects in research projects aimed at obtaining and enhancing information on the relation between drawing parameters and psychological characteristics; clearly such a method must involve digital means.

### SUMMARY OF THE INVENTION

According to the present invention there is provided apparatus and a method for digitally capturing a subject's drawings in real time and processing the resultant data to detect certain psychological characteristics of the subject. In the case that the subject is a child, the psychological characteristics may include stress factors. The apparatus comprises mainly an electronic drawing tablet, including a display screen, graphic input means for interactive on-screen drawing and storage means for storing graphic data associated with drawing actions, and a general-purpose computer, communicative with the tablet and operative to process the stored graphic data; the computer is loaded with appropriate processing software and with a data base that incorporates known relations between drawings data and psychological characteristics. Preferably the tablet is freely movable and the computer is physically separate therefrom; the computer may then generally be communicative with a plurality of tablets.

Many types of devices, available commercially or to be available in the future, may serve as the tablet; current examples include, but are not limited to, various types of a personal digital assistant (PDA), such as iPad or Blackberry, so-called smart telephones, such as iPhone and Android, and so-called electronic paper. In such devices, a finger or a stylus typically serve as the graphic input means. In some configurations of the system, the screen of a conventional general-purpose computer, such as a desktop- or portable (laptop) computer, together with its graphic input means (e.g. a mouse or a touch-pad with a stylus) may serve the functions of the tablet; in some configurations, the display screen of the computer may be overlaid with a position-sensing touch screen, operative to serve, in conjunction with a stylus or the operator's fingers, as a graphic input means. Any of the aforementioned devices will be referred to herein as a tablet.

For the case that any of the aforementioned devices is too expensive or not sturdy enough for frequent and/or exclusive use, especially by a child, the present invention also contemplates a special-purpose tablet, primarily dedicated to the stated functions of the system. The tablet typically includes a display screen, graphic input means, a controlling computer and storage memory. As input means it typically includes one or more styli, operative, in conjunction with a touch screen overlaid on the display screen and suitable software, to enter graphical data—primarily drawing lines on the screen. The tablet and the styli, which preferably are flexibly attached thereto, are constructed sturdily, as a toy, and may be of any size—preferably such that emulates a paper drawing pad. The tablet may be designed for home use or to be utilized as a diagnostic tool in an institution, such as a psychological clinic or a school.

Preferably the tablet is also operative to sense the pressure exerted by the subject while drawing on it and to store values of such pressure as a parameter. In addition to known means, the present invention also contemplates, as a novel feature, sensing the pressure exerted during drawing by detecting the width of the touched path and converting it to relative pressure values; this is possible when drawing by means of a finger or by means of a soft-tipped stylus, to be explained below.

A system to carry out the method of the present invention preferably includes two software programs: A first program, resident in the tablet's computer and to be termed the graphic input program, enables on-screen drawing, capturing parameters related to elements of each drawing and storing the captured parameters, to be termed the drawing parameters, in the tablet's storage memory. The second software program, to be termed the processing program, is operative to process stored drawing parameters, in conjunction with a data-base, to be explained below; the second program and the database may reside in the tablet's computer (if the latter has the appropriate computing capacity) or, preferably, in the separate general-purpose computer, depending on the configuration of the system.

The method of the present invention, to be preferably carried out by the means described above, comprises mainly two phases of operation—the graphic input phase and the processing phase. During the graphic input phase, a subject draws free-hand on a tablet, such as described above, interactively with the display—preferably with the aid of the aforementioned first software program. A series of values for each of several parameters associated with the drawing process are captured and stored as input data. The input data are preferably structured as sequences of strokes, each sequence corresponding to a complete drawing (or frame).

For each stroke the corresponding drawing parameter values are noted and stored. The parameters include mainly three groups—geometric, temporal and selective. Geometric parameters typically include screen coordinates of the endpoints and, optionally, of one or more intermediate points. Temporal parameters are related to time and typically include the time of each endpoint of a stroke (the time being either absolute, i.e. clock time, or relative to the start of a current sequence or drawing). Selective parameters are those selectable by the subject, such as color and line width. An optional additional parameter is drawing pressure, which may be detectable as explained above. Temporal and pressure parameters are collectively referred to herein as dynamic parameters. It is noted that the inclusion of dynamic parameters in the process is novel, inasmuch as conventional methods of psychological drawings interpretation have been operating on paper drawings, which are inherently static.

The processing phase is typically carried out on a general-purpose computer, loaded with the aforementioned second software program and in conjunction with a data base (to be explained below). It may be regarded as consisting of two subphases—preprocessing and interpretation. the preprocessing subphase includes obtaining data stored during any input phase operation, transforming the obtained data into values of derived parameters, grouping successive strokes into classifiable pictorial primitives, such as polygons or area hatching, combining strokes and derived pictorial primitives into iconographic elements, and deriving geometric relationships among pictorial primitives and/or iconographic elements.

Data from dynamic parameters, i.e. those associated with time and/or drawing pressure, applied in several ways, including deriving overall statistics and associating them with the derived pictorial primitives or iconographic elements.

During the interpretation subphase, parameter values and results of the preprocessing subphase are examined in association with a stored database, which, in effect, incorporates relationships between drawing parameters and any data derivable therefrom, on the one hand, and psychological characteristics of corresponding subjects, on the other hand.

The method has two distinct application modes, characterized in the interpretation subphase—normal mode and study mode. In the normal mode, psychological characteristics corresponding to currently obtained and preprocessed drawing data are extracted from the data base. The extracted characteristics are subsequently output—e.g. in the form of a report. They may also be used in a subsequent screening process, in order to possibly identify situations that need attention, such as indications of stress or fear.

The study mode is provided for researchers conducting empirical studies with subjects having known psychological characteristics, aimed at establishing or improving the relationships stored in the database. It is noted that the method of the present invention provides add ional information from the drawing process, not hitherto considered in psychological interpretation of drawings, which may however be significant. Such information includes particularly the dynamics of the drawing (i.e. time-related parameters and pressure) but also the possibility of measurement and statistical processing of a large quantity of data about individual strokes and graphic primitives. The method thus opens up, in effect, a new area of psychological knowledge and, in its study mode, enables researchers to establish and enhance such knowledge.

The method of the present invention, in its normal mode, is applicable both as a diagnostic tool for a professional person, complementing and enhancing his ability to interpret a subject's drawings, and as part of an automatic monitoring system. In the latter capacity, it is particularly applicable to monitoring children—at home or in school—in order to detect early signs of an abnormal psychological state. With the provision of an electronic tablet to be at the free disposal of a subject, as disclosed herein, the subject may execute a large number of drawings, in a variety of situations, which, in turn, may increase the reliability of the subsequent interpretation; the ability to handle the resulting large amount of data is another advantage of computerized processing, as in the present method.

The advantages of a system according to the present invention, over extant computer-based drawings analysis and -diagnosis programs or systems that involve scanning of paper drawings, emanate from its novel characteristic of capturing the drawing strokes in real time and thus they include (a) having the analysis or interpretation program operate also directly on the encoded stroke data, rather than on two-dimensional image scanning data, thus significantly simplifying it and (b) having the option of including also attendant dynamic data, such as drawing speed and -rhythm and possibly hand pressure.

On the other hand, the advantages, especially in cases of minor subjects, of a system according to the present invention, over extant computer-based drawings analysis and -diagnosis programs or systems that involve on-screen drawing are that it provides means, namely the tablet, that can serve for drawing at times and places convenient to the subject, thus (a) putting him at ease, without supervision or artificial prompting and (b) providing drawing opportunities at a variety of everyday situations, moods and times of day. In the case of home use by minor subjects, the invented system has an additional psychological advantage in that the child regards the tablet as his toy and thus can readily familiarize himself with its operation and feel at ease, so as to freely express his emotions.

Optionally, the drawing program also enables displaying on the screen predefined elements, such as shapes and patterns, and using them constructively in the drawing process—instead of, or in addition to, freehand strokes. In that case, the processing program considers also these elements and their attended parameters in the interpretation process. Another option is for the processing program to generate patterns and other prompts, including verbal instructions and questions, based on tentative results, thus directing the subject to further, possibly more meaningful, drawing activity. It will be appreciated that, although the description herein is in terms of children as subjects, a system according to the present invention can be adapted to advantageously serve also for diagnostic analysis of drawings by adult subjects.

More concisely, the present invention is of a method for digitally relating psychological characteristics of a subject to on-screen drawings, comprising—
a) providing a display screen and graphic input means that enable the subject to graphically interact with the screen, the interaction including drawing a sequence of strokes, the strokes being associated with a plurality of parameters, at least one of the parameters being temporal and at least one parameter being geometric;
b) providing a data base that contains relations between stroke parameters and psychological characteristics;
c) letting the subject to graphically interact with the screen and capturing and storing values of parameters corresponding to one or more strokes drawn by the subject in any of the sequences;
d) relating the captured parameter values from one or more of the sequences to contents of the data base.

Preferably, the display screen and the graphic input means are provided in a portable package that is handleable by the subject.

Optionally, the data base also stores relations between patterns and psychological characteristics and the method further comprising—
e) combining geometric parameters values corresponding to a plurality of strokes, to form one or more patterns;
f) relating any of the patterns, singly or in combination, to patterns in the data base.

Also optionally, the parameters include graphic pressure and the graphic input means include means for transforming physical pressure by the subject into input stroke width, the method then further comprising
g) For any stroke drawn by the subject, transforming input stroke width values into corresponding graphic pressure parameter values.

The “relating” in step d may include extracting psychological characteristics from the data base or, alternatively in the case that psychological characteristics of the subject are known to a researcher, it may include modifying or adding to relations in the data base by the researcher.

The invention also contemplates a sturdy graphic tablet, comprising—
a computing device,
a storage memory,
a display screen having at least the size of a standard letter and
a touch screen overlying the display screen and cooperative with any touch tool to input screen positions,
the tablet being operative—
to enable a person to draw a sequence of strokes on the screen and
to input corresponding stroke data to the memory, the data for each stroke being corresponding values of a plurality of parameters, at least one of the parameters being temporal.

Preferably, in such a tablet the stroke data are parameter values that may be related to psychological characteristics.

Optionally, the touch tool has a soft tip, such that, when in contact with the touch screen, the number of screen positions that may be input simultaneously increases with the force exerted by the tip on the touch screen. One of the parameters is then related to drawing pressure and any value thereof is determined for any stroke from the number of screen positions being input simultaneously across the stroke.

Also disclosed is a touch tool, cooperative with a touch screen to detect positions thereon, the tool comprising a pen-like body and a soft tip, such that when the tip is pressed against the screen, a plurality of adjacent positions on the screen are detectable simultaneously, the number of the positions being commensurate with the force exerted by the tip on the touch screen.

The invention also contemplates a system that comprises one or more tablets and a computer, communicative with the tablets and loaded with a data base that contains relations between stroke parameters and psychological characteristics, the tablets and the computer being operative to carry out steps of the method disclosed herein.

### LIST OF ILLUSTRATIONS

Further details of the construction and operation of a preferred embodiment of the method and apparatus according to the invention will now be described, with reference to the accompanying drawings, of which—

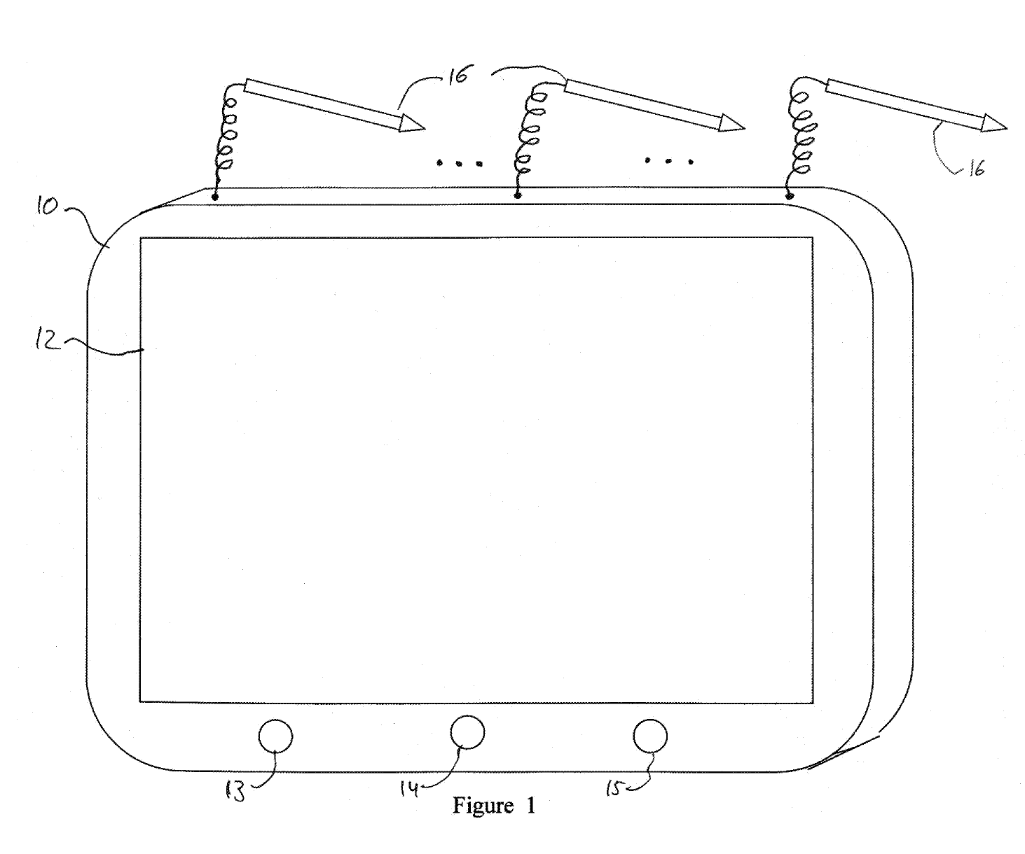

FIG. 1 is a schematic drawing, showing a drawing tablet according to an embodiment of one aspect of the invention; and

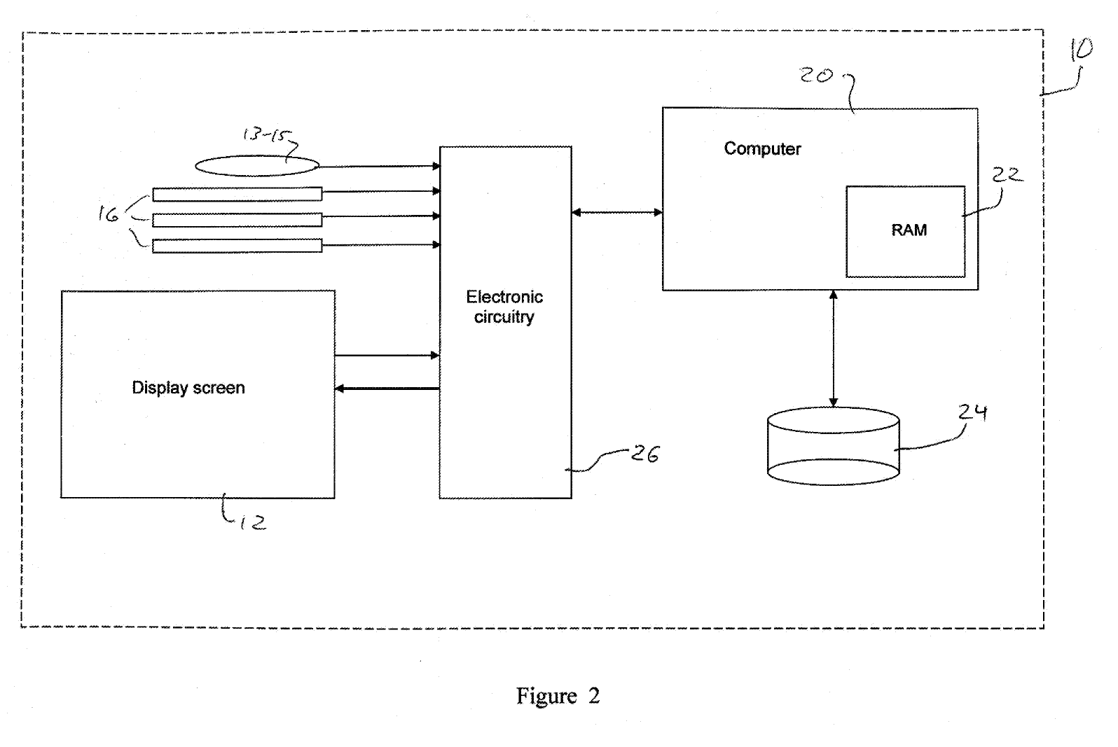

FIG. 2 is a block diagram, showing the internal components of the tablet of FIG. 1.

### DESCRIPTION OF PREFERRED EMBODIMENTS OF THE INVENTION

Apparatus to carry out the method of the present invention preferably comprises (a) an electronic drawing tablet, including a display screen, graphic input means for interactive on-screen drawing, storage means for storing graphic data associated with drawing actions and a computer, or digital processor, loaded with an appropriate software program, to be termed the graphic input program, and operative, inter alia, to enable the drawing and storing operations, and (b) a general-purpose computer, communicative with the tablet and operative to process the stored graphic data; the computer is loaded with an appropriate processing software program, to be termed the processing program, and with a data base that incorporates known relations between drawings data and psychological characteristics—all as explained further below. The general-purpose computer may be physically incorporated with the tablet, but generally would be separate therefrom and may then be communicative with a plurality of tablets.

Preferably the tablet is freely movable. Many types of devices, available commercially or to be available in the future, may serve as the tablet; current examples include, but are not limited to, various types of a personal digital assistant (PDA), such as iPad or Blackberry, so-called smart telephones, such as iPhone and Android, and so-called electronic paper. In such devices, a combination of a touch screen, overlying the display screen, and a touch tool, which may be a finger or a stylus, typically serve as the graphic input means. In some configurations of the system, the screen of a conventional general-purpose computer, such as a desktop- or portable (laptop) computer, together with its graphic input means (e.g. a mouse or a touch-pad with a stylus) may serve the functions of the tablet; in some configurations, the display screen of the computer may be overlaid with a position-sensing touch screen, operative to serve, in conjunction with a stylus or the operator's fingers (collectively referred to as touch tool), as a graphic input means. Any of the aforementioned devices will be referred to herein as a tablet. For the case that any of the aforementioned devices is too expensive or not sturdy enough for frequent and/or exclusive use by a child, the present invention also contemplates a special-purpose tablet, primarily dedicated to serving the stated functions of the present method; it is described further below.

The method of the present invention, to be preferably carried out by the means described above, comprises mainly two phases of operation—the graphic input phase and the processing phase. During the graphic input phase, a subject draws free-hand on a tablet, such as described above, interactively with the display, moving the drawing tool (e.g. the touch tool) of the graphic input device while a line on the screen is generated correspondingly—preferably with the aid of an appropriate drawing program, such is commonly available and which may be included in the aforementioned first software program. For each line, or series of lines, the subject may select a color and possibly also a line width. In the case that means are provided for sensing drawing pressure, as explained above, pressure values may be translated in the display into line intensity values (e.g. degree of darkness) and/or into line width values. Optionally, the subject may delete lines or strokes. When the subject considers the drawing to be complete (or otherwise wishes to stop), he pushes a “finish” button. Additional optional functions that may be included in the drawing program include line continuity assurance (to fill out erroneous gaps) and erasure of artifacts, such as marks caused by inadvertent touch of the screen by the subject's hand (other than a drawing finger).

A series of values for each of several parameters associated with the drawing process are captured and stored as input data. The input data are preferably structured as sequences of strokes, each sequence corresponding to a complete drawing (or frame). A stroke corresponds to an individual continuously drawn line, defined by two endpoints at which, for example, the drawing tool (e.g. the stylus) respectively makes or breaks contact with the drawing surface or at which the direction of drawing abruptly changes (such as at corners of a polygon or in a series of area-filling strokes); optionally also points of temporary standstill of the tool (while keeping touch with the surface) are regarded as endpoints.

For each stroke the corresponding drawing parameter values are noted and stored. The parameters include mainly three groups—geometric, temporal and selective. Geometric parameters typically include coordinates of the endpoints and, optionally, of one or more intermediate points. Before storage, they may be transformed into derived geometric parameters, such as line length, direction and radius of curvature. Temporal parameters typically include the time of each endpoint and may be transformed also to a duration parameter. Selective parameters are those selectable by the subject, such as color and line width. An optional additional parameter is drawing pressure, which may be detectable as explained above; one or more pressure values along each stroke may be noted and stored. Temporal and pressure parameters are collectively referred to herein as dynamic parameters. It is noted that the inclusion of dynamic parameters in the process is novel, inasmuch as conventional methods of psychological drawings interpretation have been operating on paper drawings, which are inherently static. An additional parameter to be stored is whether the stroke corresponds to a single line or a segment of a longer line (as defined above).

The processing phase is typically carried out, at times unrelated to the graphic input phase, on a general-purpose computer, loaded with the aforementioned second software program and in conjunction with a data base (to be explained below). It may be regarded as consisting of two subphases—preprocessing and interpretation. As a first step, the preprocessing subphase includes obtaining data stored during any input phase operation, i.e. drawing parameters associated with one or more drawings, drawn by one or more subjects. Other early operations in the preprocessing subphase may include—

(a) transforming the obtained data of certain drawing parameters into values of other parameters, more useful for subsequent processing—for example, stroke endpoint coordinates into stroke length and direction, stroke length and endpoint times into stroking speed or differences between successive stroke times into stroking frequency;
(b) grouping successive strokes into pictorial classifiable pictorial primitives, such as polygons or area hatching; and—
(c) identifying complex strokes, such as long curved lines or circles.

It is noted that some or all operations listed in ‘a’ may, in some configurations, be part of the graphic input phase.

Subsequent operations may include—

(d) combining strokes and derived pictorial primitives into ichnographic elements, such as a house, an animal or a human figure; and—
(e) deriving geometric relationships among pictorial primitives and/or ichnographic elements, such as relative positions or sizes.

Data from dynamic parameters, i.e. those associated with time and/or drawing pressure, as well as selective parameters, may be processed in several ways, including—

(f) deriving overall statistics, such as average and variance of stroking speed or of pressure, or dominant colors; and—
(g) associating the parameters with the derived pictorial primitives or ichnographic elements.

During the interpretation subphase, parameter values and results of the preprocessing subphase are examined in association with a stored database, which, in effect, incorporates relationships between drawing parameters and any data derivable therefrom, on the one hand, and psychological characteristics of corresponding subjects, on the other hand. The relationships may be expressed in any of a number of ways, including (but not limited to) formulas, algorithms, multi-dimensional tables or combinations thereof. Typically results from one sequence, or frame (e.g. one picture), are considered at a time. However, also a plurality of sequences may be considered together, inasmuch as there is significant information in some comparative data between the sequences, or in certain recurring values.

The interpretation subphase has two distinct modes—normal mode and study mode—which terms may also be applied correspondingly to the method as a whole. In the normal mode, psychological characteristics corresponding to currently obtained and preprocessed drawing data are extracted from the data base. Depending on the manner in which the relationships are expressed in the database, the extraction is effected by either applying the drawing data to the database (as, for example, in the case of formulas or algorithms) or by searching the database for similar values. The extracted characteristics are subsequently output—e.g. in the form of a report. They may also be used in a subsequent screening process, in order to possibly identify situations that need attention, such as indications of stress or fear.

The study mode is provided for researchers conducting empirical studies with subjects having known psychological characteristics, aimed at establishing or improving the relationships stored in the database. It is noted that the method of the present invention provides add ional information from the drawing process, not hitherto considered in psychological interpretation of drawings, which may however be significant. Such information includes particularly the dynamics of the drawing (i.e. time-related parameters and pressure) but also the possibility of measurement and statistical processing of a large quantity of data about individual strokes and graphic primitives. The method thus opens up, in effect, a new area of psychological knowledge and, in its study mode, enables researchers to establish and enhance such knowledge.

During early stages of research, information known from past conventional experience may be formalized into expressions suitable to become a preliminary database. During subsequent stages, the method disclosed herein, in its study mode, may be applied in a heuristic manner, so as to identify, for example, the most relevant parameters or data types that result from the preprocessing subphase or to suggest additional preprocessing operations. After that, the study mode may be run so as to tentatively associate certain data patterns with certain psychological characteristics, establishing corresponding tentative relational expressions. The tentative expressions are then tested on data from additional known subjects and possibly modified or refined accordingly.

The method of the present invention, in its normal mode, is applicable both as a diagnostic tool for a professional person, complementing and enhancing his ability to interpret a subject's drawings, and, once sufficient information is accumulated in the database, as part of an automatic monitoring system. In the latter capacity, it is particularly applicable to monitoring children—at home or in school—in order to detect early signs of an abnormal psychological state. As noted above, the method includes the provision of an electronic tablet. This may be any of a variety of devices, but portable devices with direct on-screen graphic input facility can best serve the purpose of child monitoring because they provide him the same mechanical and expressive freedom as when drawing with a pencil or crayon on paper or similar medium. For the same reason, however, the screen should be relatively large—about the size of a drawing pad. Presently the only devices that meet both of these requirements are PDAs, such as iPad and Blackberry, but these are relatively expensive and therefore not likely to be at the free disposal of a child. Such a free disposal encourages the child to execute a large number of drawings, in a variety of situations, which, in turn, may increase the reliability of the subsequent interpretation; it is noted, in passing, that the ability to handle the resulting large amount of data is another advantage of computerized processing, as in the present method. Moreover, such devices may not be sturdy enough to withstand the rough handling that they may encounter in the hands of small children.

The present invention therefore contemplates also a novel type of a tablet, to serve for drawing by children, that is characterized by a relatively large size—on the order of a standard sheet of writing paper, sturdiness and low cost. The low cost is achieved by setting relatively low requirements on screen resolution and image quality and by using a low-performance, possibly custom-designed, computer chip. The tablet includes a touch screen, drawing being effected by means of a finger or a stylus.

The present invention contemplates also novel means for providing drawing force values, as optionally required by the method and discussed hereabove. In the case that a stylus serves as the touch tool (in conjunction with a touch screen or -pad), the tip of the stylus is advantageously formed as a soft cushion or pad that spreads under pressure. Such a stylus is then used during drawing of a line (i.e. a stroke), as is also a drawing finger, to sense the relative force by counting the number of touch-screen pixels across the stroke that are touched by the tip of the stylus or the finger.

As mentioned above, the present invention also contemplates a special-purpose tablet, primarily dedicated to the stated functions of the method.

Reference is first made to FIG. 1, which illustrates an embodiment of a drawing tablet according to the invention in a typical configuration. The body of the tablet 10 is constructed of sturdy material so that it can be handled by a small child and will not break under rough handling by him. Its size is typically that of a standard sheet of writing paper (e.g. A4), but may also be larger (e.g. that of an A3 sheet). Most of its front surface consists of an electronic display screen 12, capable of displaying color images with a resolution of typically 7 to 20 pixels/cm. Outside the screen there are three push button 13, 14 and 15, marked respectively by “on” (or “begin drawing”), “finish” (or “off”) and “erase”; they may also be color-coded and/or marked also with suitable icons. Mechanically and electrically attached to the tablet, through respective strong cables, are a number of styli 16. The styli are shaped to emulate typical drawing crayons. Each stylus, and preferably its respective cable, has a unique color. Preferably the tablet includes arrangements (not shown) for conveniently holding the styli when not in use. Display screens are known in the art, using various techniques; a so-called LCD technique, for example, may be most practical, but others may be considered.

The tablet 10 includes an arrangement for locating the position of the tip of a stylus 16 when touching the screen 12. The arrangement is operative to detect whether the tip touches the screen and to supply X and Y coordinate values (with respect to the screen) periodically as long as the touch continues. In addition, the arrangement is operative to identify the stylus that is touching the screen (the active stylus). Several methods and techniques are known in the art for locating the stylus on the display screen and detecting its touch, a practical one, for example, being the so-called touch-screen technique. Others to be considered may require an active element at the tip of each stylus, which send signal to, or receives signals from, devices along two edges of the screen. Identifying the active stylus may preferably be done by means of unique signals emanating from the variously colored styli and received by appropriately located detectors at the screen.

In an alternative configuration of tablet 10 there is provided only a single stylus 16 (with its connecting cable), but the tablet includes additional, differently colored push-buttons, operative to select respective colors for drawing. It is noted that in some embodiments of the tablet, some or all the push-buttons may be replaced by virtual buttons on the screen and serve to function upon touching by a stylus 16 or possibly by a finger.

In some configurations, tablet 10 additionally includes an arrangement for measuring the force exerted by the operator (the child) through any of the styli 16 on the face of the tablet (i.e. on the screen) and is operative to store values of such force as a parameter. Means for force sensing may include, but are not limited to, a force sensor in the stylus or in the touch screen. The present invention also contemplates, as a novel feature, sensing the force exerted during drawing by detecting the width of the touched path and converting it to relative pressure values; this is possible when drawing by means of a finger or by means of a soft-tipped stylus, to be explained below.

Referring now to FIG. 2, tablet 10 includes, internally, a computer or digital processor 20 (which includes a working memory 22), a storage memory 24 and electronic circuitry 26. The electronic circuitry is operative, inter alia, to drive the display screen 12 and to receive signals from the styli 16 including, possibly, signals pertaining to stylus force) and from any electronic arrangements, mentioned above, for locating and identifying the styli on the screen. The tablet preferably also includes a replaceable or rechargeable battery, to supply power to all the components. Computer 20 consists typically of commercially available semiconductor components and runs by software that includes an operating system, such as is known in the art, drivers for the electronic circuitry 26 and a drawing program, to facilitate on-screen drawing and creating drawing data files, as described below. The computer 20 is connectable to any external computer (not shown)—preferably by means of a USB (Universal Serial Bus) cable; optionally the connection may also be over a network and may be by means of a wireless path, such as Bluetooth or WiFi. The connection serves, inter alia, to download software programs to the tablet computer and to upload drawing data from storage memory 24 to the external computer. Alternatively, the data may be transferred by means of a removable storage device (such as so-called disc-on-key). Working memory 22 is a RAM, with capacity large enough to hold full image data for the entire screen 12 plus what is necessary for the drawing program to run, including buffered data. Storage memory 24 is preferably of the electrostatic type, such as Flash memory, and serves to store the software programs and accumulated drawing data; all or part of it may be in a removable storage device. In the latter case, data may be transferred directly from the storage device to the external computer.

An analytical program, such as the processing program described above, to operate on the drawing data files, may also reside in computer 20 and be operable within the tablet alone, but preferably resides in an external computer, where better operational tools and available Internet connections may enhance its effectiveness.

Operation of the tablet, in conjunction with the software programs, will now be described; it is assumed that a child is the operator. The operation is presented here as an example for operating a tablet more generally, as part of the method disclosed herein. After the child presses the “on” button he would pick one stylus at a time, according to the color he chooses, and draws with it on the screen—supposedly in a series of strokes, between which he lifts the stylus from the screen or abruptly changes direction.

When the “on” button is pressed, the drawing program is loaded into the working memory (if not already resident), it begins to run and a new drawing file is created. Whenever a stroke is drawn, with the stylus, it is traced as a correspondingly colored line on the screen and it is recorded as follows: The stroke begins when a first touch of the stylus on the screen is sensed and ends when a touch is no longer sensed. During each stroke, i.e. as long as the stylus touches the screen, the stylus X and Y position is repeatedly sampled—either periodically or upon each incremental change of predetermined magnitude. When the lifting of the stylus from the screen is sensed, the accumulated sequence of XY value pairs is entered as corresponding stroke data in the drawing file, together with the stylus identity (i.e. color) and the times of the stroke's beginning and end; if available, also sensed stylus force values are entered and may optionally affect the width or strength of the traced line on the screen. Such an entry is made for each stroke, in sequence, until the “finish” button is pushed. When the “erase” button is pushed, all the data from the current stroke are erased; subsequent pushes of the button may cause data of immediately preceding strokes to be erased. After the “finish” button is pressed, or after a predetermined time period has elapsed since the last drawing operation, the file is closed and stored in the storage memory.

Similar drawing sessions may follow, each resulting in another drawing sequence, resulting in a corresponding file. At any time, one or more drawing files may be transferred from the storage memory to be processed.

From time to time, the processing program is run on accumulated drawing files, as described above. In addition to extracting psychological characteristics from individual files (i.e. stroke sequences—corresponding to individual drawings or pictures or frames), the program may inter-relate the results from several files, attempting to determine consistencies and repetitions between them. Subsequently, the program examines the overall results, attempting to detect specific psychological symptoms. During such examination, the program may, inter alia, classify the results into given categories and/or compare them with a given lexicon of symptoms, or do any operation indicated by the chosen diagnostic method.

Finally the program issues a report, summarizing the diagnostic findings. The report may include references to related information and suggestions for further actions, including references to professional help, etc. The report will, of course, be adapted to the circumstances under which the system is being used—e.g. whether it is used at home or in a professional environment. One possible mode of operation may, for example, be that the tablet is used at home, but the analytical program is run in a clinic, whereto the data is sent from the home—for example, via the Internet.

In certain configurations of the system according to the present invention, rather than recording drawing data only in terms of strokes, as described hereabove, the software programs may alternatively or additionally be configured to record drawings and subsequently to analyze them, as complete images—e.g. as pixel values over the entire screen area. In such a configuration, some of the advantages of the invented system will be lacking. However, existing analysis- or interpretation methods and programs (which aim at data from scanned images) may then be more readily usable, or adaptable for use, during the analysis and diagnostic phase.

Finally it is noted that, although the invention has been described herein as pertaining to a child as the subject for monitoring and testing, the invention is equally applicable to other types of subjects, such as adult patients in a psychiatric clinic or participants in any of a variety of psychological testing programs.

I claim:

1. A method for digitally relating psychological characteristics of a subject to on-screen drawings, comprising—
a) providing a display screen and graphic input means that enable the subject to graphically interact with the screen, the interaction including drawing a sequence of strokes, the strokes being associated with a plurality of parameters, at least one of the parameters being temporal;
b) providing a data base that contains relations between stroke parameters and psychological characteristics;
c) letting the subject to graphically interact with the screen and capturing and storing values of parameters corresponding to one or more strokes drawn by the subject in any of said sequences;
d) relating the captured parameter values from one or more of the sequences to contents of the data base.

2. The method of claim 1, wherein said display screen and said graphic input means are provided in a portable package that is handleable by the subject.

3. The method of claim 1, wherein said parameters include at least one geometric parameter and wherein the data base also stores relations between patterns and psychological characteristics, the method further comprising—
e) combining geometric parameter values corresponding to a plurality of strokes, to form one or more patterns;
f) relating any of said patterns, singly or in combination, to patterns in the data base.

4. The method of claim 1, wherein said parameters include graphic pressure

5. The method of claim 4, wherein said graphic input means include means for transforming physical pressure by the subject into input stroke width, further comprising—
g) For any stroke drawn by the subject, transforming input stroke width values into corresponding graphic pressure parameter values.

6. The method of claim 1, wherein said relating in step d includes extracting psychological characteristics from the data base.

7. The method of claim 1, wherein psychological characteristics of the subject are known to a researcher and said relating in step d includes modifying or adding to relations in the data base by the researcher.

8. A portable sturdy graphic tablet, comprising—
a computing device,
a storage memory,
a display screen having at least the size of a standard letter and
a touch screen overlying the display screen and cooperative with any touch tool to input screen positions,
the tablet being operative—
to enable a person to draw a sequence of strokes on the screen and
to input corresponding stroke data to the memory, the data for each stroke being corresponding values of a plurality of parameters, at least one of the parameters being temporal.

9. The tablet of claim 8, wherein said stroke data are parameter values that may be related to psychological characteristics.

10. The tablet of claim 8, wherein said touch tool has a soft tip, such that, when in contact with said touch screen, the number of screen positions that may be input simultaneously increases with the force exerted by the tip on the touch screen.

11. The tablet of claim 10, wherein one of said parameters is related to drawing pressure, any value thereof being determined for any stroke from the number of screen positions being input simultaneously across the stroke.

12. A system for digitally relating psychological characteristics of a subject to on-screen drawings, comprising—
a) At least one graphic tablet, each including a display screen, a storage memory and graphic input means that enable the subject to graphically interact with the screen, the interaction including drawing a sequence of strokes, the strokes being associated with a plurality of parameters, at least one of the parameters being related to time, the tablet being configured to store in said memory values of said parameters corresponding to at least one sequence of strokes drawn by the subject.
b) a computer, communicative with said tablets and loaded with a data base that contains relations between stroke parameters and psychological characteristics, the computer being programmed to process parameter values stored in said memory, the processing to include relating said parameter values to contents of the data base.

13. A touch tool, cooperative with a touch screen to detect positions thereon, the tool comprising a pen-like body and a soft tip, such that when the tip is pressed against the screen, a plurality of adjacent positions on the screen are detectable simultaneously, the number of said positions being commensurate with the force exerted by the tip on the touch screen.
